(19) United States
(12) Patent Application Publication
(10) Pub. No.: US 2025/0292931 A1
(43) Pub. Date: Sep. 18, 2025

(54) LUMINOUS DATA CABLE

(71) Applicants: QIANG GAO, Huaihua (CN); WENBIN PAN, Ruian (CN)

(72) Inventors: QIANG GAO, Huaihua (CN); WENBIN PAN, Ruian (CN)

(21) Appl. No.: 18/607,793

(22) Filed: Mar. 18, 2024

(51) Int. Cl. H01B 7/18; F21V 8/00; H01B 7/32; H01R 13/66

(52) U.S. Cl. CPC H01B 7/1855; G02B 6/0053; H01B 7/32; H01R 13/6683

(57) ABSTRACT

A luminous data cable is provided, which includes a data cable, a wrapping sleeve configured to protect the data cable, and an inner wire rod configured to emit light. Two ends of the data cable are respectively connected with a first joint and a second joint of the data cable. The wrapping sleeve is a hollow structure, several wrapping sleeves are wrapped around an outside of the data cable. The inner wire rod is arranged along an axial direction inside the wrapping sleeve, staggered positions of the several wrapping sleeves are fixed by a support sleeve, the data cable is wrapped with multiple sets of wrapping sleeves to provide an external support and protection for the data cable; by providing the inner wire rod inside the wrapping sleeve to provide a prompt for the data cable.

### TECHNICAL FIELD

The present disclosure relates to the field of data cable technologies, and in particular, to a luminous data cable.

### BACKGROUND

A data cable is a cable or wire cable used for transmitting data. It is usually used to connect a computer, a mobile device, an external storage device, a printer, and other devices so that data can be exchanged between them. Data cable is also called as a USB cable, a charging cable, a transmission cable, etc., and their specific names depend on their usage scenarios and functions.

In existing technology, most luminous data cables emit light directly through a light strip or an optical fiber. However, light strip increases heat generation, light from the optical fiber is too dazzling. In addition, the data cable often experiences bending or being subjected to an impact during use, which is difficult to detect externally and poses safety hazards in a subsequent use.

### SUMMARY

The purpose of the present disclosure is to provide a luminous data cable to solve the above-mentioned problem.

The present disclosure achieves the above purposes through the following technical solutions.

A luminous data cable including a data cable, a wrapping sleeve configured to protect the data cable, and an inner wire rod configured to emit light, two ends of the data cable are respectively connected to a first joint of the data cable and a second joint of the data cable; the wrapping sleeve is a hollow structure, several wrapping sleeves are wrapped around an outside of the data cable; an inner part of the wrapping sleeve is provided with the inner wire rod along an axial direction, staggered positions of the wrapping sleeves are fixed by a support sleeve;
the inner wire rod includes a plastic optical fiber provided at one in in the wrapping sleeve that is close to the data cable, a transparent layer provided on an outer side of the plastic optical fiber, and a frosted layer provided between the plastic optical fiber and the transparent layer;
two sides of an inner of the first joint of the data cable is provided with a light sensor.

In an embodiment of the present disclosure, the wrapping sleeve is made of a transparent material, the frosted layer is made of a brittle material.

In an embodiment of the present disclosure, the support sleeve is connected to the wrapping sleeve by an adhesive.

In an embodiment of the present disclosure, the plastic optical fiber is electrically connected to the light sensor.

In an embodiment of the present disclosure, the support sleeve is made of a plastic material.

Compared with existing technology, the beneficial effects of the present disclosure are as follows:

1. the data cable is wrapped with multiple sets of wrapping sleeves to provide an external support and protection for the data cable.

2. By proving the inner wire rod inside the wrapping sleeve to provide a prompt for the data cable, a frosted layer is used to polish light emitted by the plastic optical fiber, thereby avoiding glare. Moreover, when a device is subjected to an excessive impact and causes a damage to the frosted layer, the transparent layer can quickly fill a gap in the frosted layer, thereby reminding the outside world that there is a hidden danger in an integrity of the data cable due to a significant impact at this location, thus reminding the outside world.

3. A light sensor is used to detect an external light, luminous intensity of plastic optical fiber is high when an external light is strong, and luminous intensity of plastic optical fiber is high is weak when the external light is weak, thereby avoiding glare.

### BRIEF DESCRIPTION OF DRAWINGS

In order to provide a clearer explanation of the embodiments of the present disclosure or the technical solutions in the prior art, a brief introduction will be given below to the accompanying drawings required in the embodiments or prior art description. It is evident that the accompanying drawings in the following description are only some embodiments of the present disclosure. For those skilled in the art, other accompanying drawings can be obtained based on these drawings without creative work.

FIG. 1 is a structural schematic diagram of a luminous data cable according to the present disclosure.

FIG. 2 is a structural schematic diagram of a wrapping sleeve of the luminous data cable according to the present disclosure.

FIG. 3 is a partial detail diagram of the wrapping sleeve of the luminous data cable according to the present disclosure.

FIG. 4 is a structural schematic diagram of a support sleeve of the luminous data cable according to the present disclosure.

FIG. 5 is a structural schematic diagram of an internal wire rod of a light sensor of the luminous data cable according to the present disclosure.

FIG. 6 is a structural schematic diagram of a position relationship of the photosensor of the luminous data cable according to the present disclosure.

Numeral reference: 1. First joint of data cable; 2. Second joint of the data cable; 3. Data cable; 4. Wrapping sleeve; 5. Light sensor; 6. Inner wire rod; 7. Support sleeve; 61. Plastic optical fiber; 62. Frosted layer; 63. Transparent layer.

### DESCRIPTION OF EMBODIMENTS

In the description of the present disclosure, it should be understood that terms “center”, “longitudinal”, “horizontal”, “up”, “down”, “front”, “back”, “left”, “right”, “vertical”, “longitudinal”, “top”, “bottom”, “inside”, “outside”, etc. indicate an orientation or position relationship based on the orientation or position relationship shown in the drawings, only for a convenience of describing the present disclosure and simplifying the description, rather than indicating or implying that the device or component referred to must have a specific orientation, be constructed and operated in a specific orientation, it cannot be understood as a limitation of the present disclosure. In addition, terms “first”, “second”, etc. are only used to describe a purpose and cannot be understood as indicating or implying a relative importance or implying the number of technical features indicated. Therefore, the features limited to “first”, “second”, etc. may explicitly or implicitly include one or more of these features. In the description of the present disclosure, unless otherwise specified, “multiple” means two or more.

In the description of the present disclosure, it should be noted that unless otherwise specified and limited, terms “installation”, “connection to”, and “connection with” should be broadly understood, for example, they can be a fixed connection, a detachable connection, or an integrated connection; it can be a mechanical connection or an electrical connection; it can be directly connected, or indirectly connected through an intermediate medium, or it can be an internal connection between two components. For ordinary technical personnel in this field, specific meanings of the above terms in the present disclosure can be understood through a specific circumstance.

The following is a further explanation of the present disclosure in combination with the accompanying drawings.

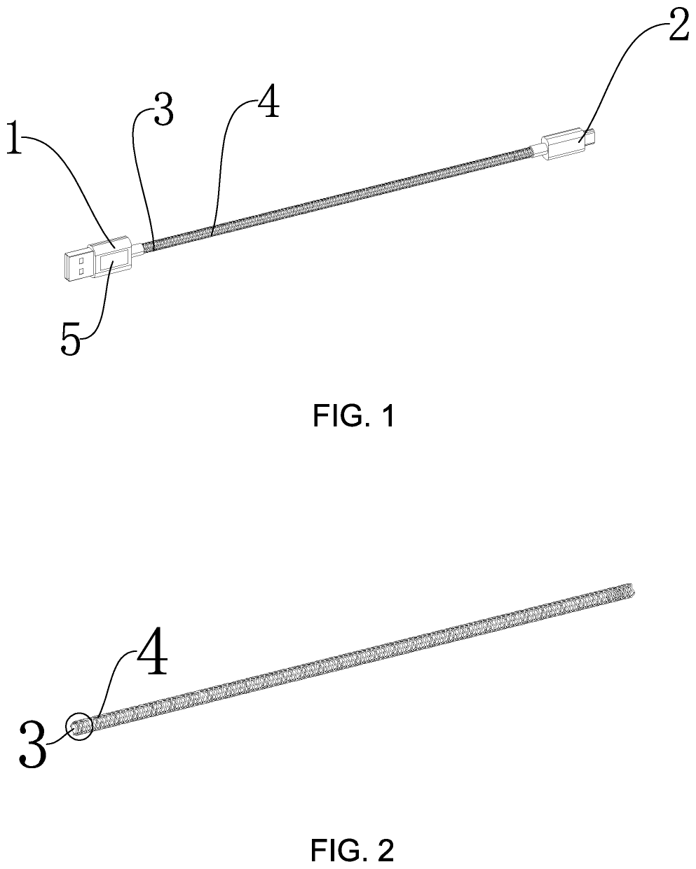

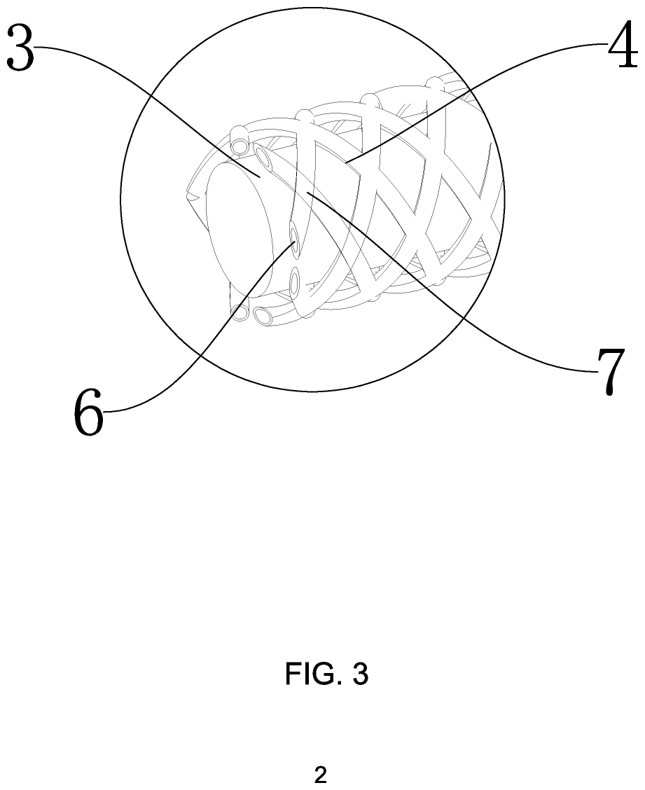

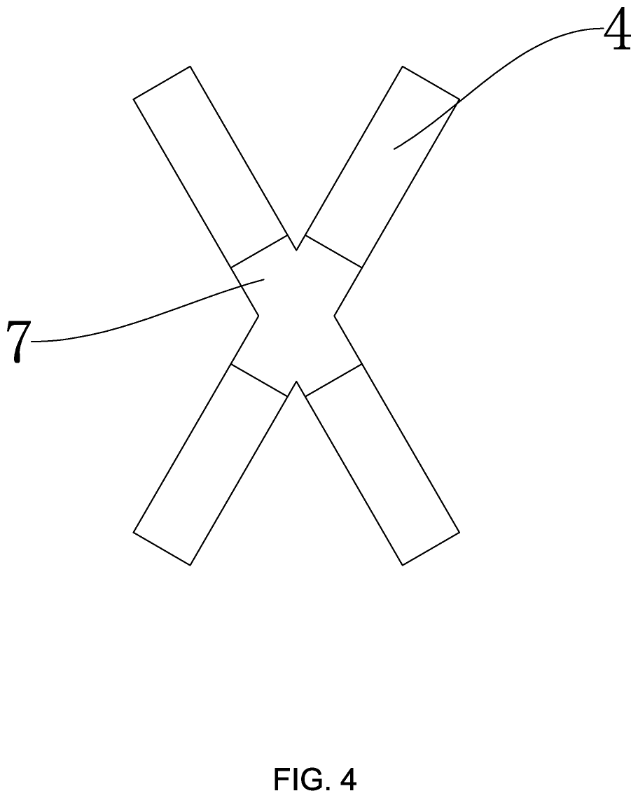

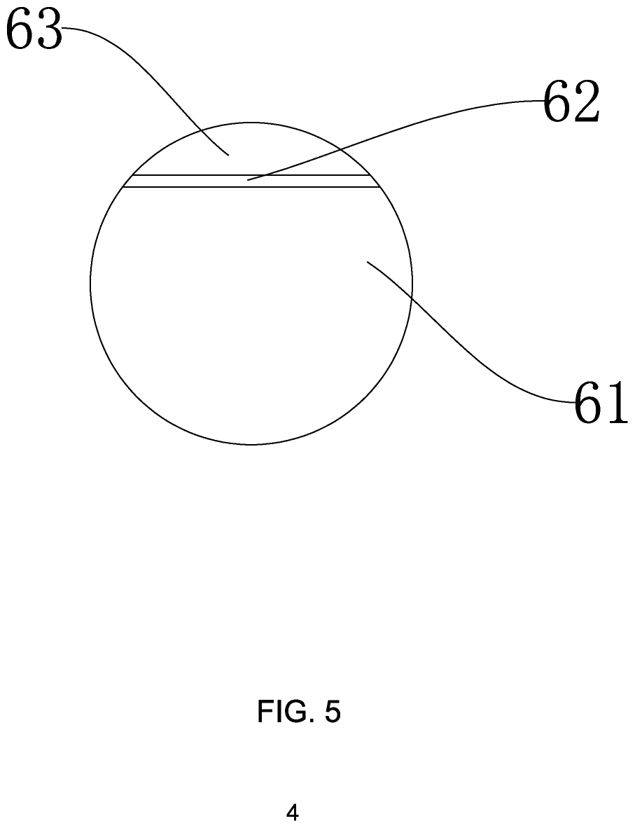

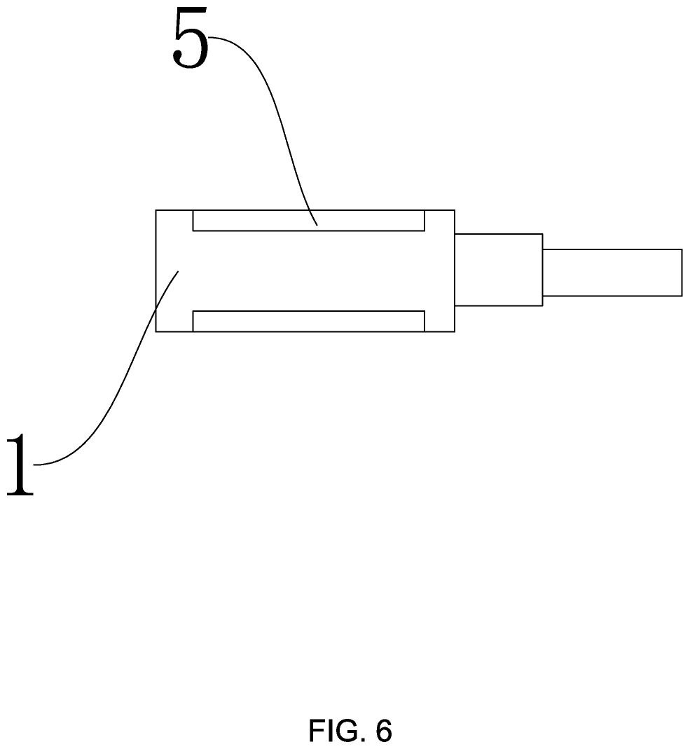

As shown in FIGS. 1-6, a luminous data cable includes a data cable 3, a wrapping sleeve 4 for protecting the data cable 3, and an inner wire rod 6 for emitting light. Two ends of the data cable 3 are respectively connected to a first joint 1 of the data cable and a second joint 2 of the data cable. The wrapping sleeve 4 is a hollow structure, several wrapping sleeves 4 are wrapped around an outside of the data cable 3. An inner part of the wrapping sleeve 4 is provided with the inner wire rod 6 along an axial direction, staggered positions of the several wrapping sleeves 4 are fixed through a support sleeves 7.

The inner wire rod 6 includes a plastic optical fiber 61 provided at one side in the wrapping sleeve that is close to the data cable 3, a transparent layer 63 provided on an outer side of the plastic optical fiber 61, and a frosted layer 62 provided between the plastic optical fiber 61 and the transparent layer 63.

Two side of an inner of the first joint 1 of the data cable is provided with a light sensor 5.

In this embodiment, the wrapping sleeve 4 is made of a transparent material, the frosted layer 62 is made of a brittle material.

In this embodiment, the support sleeve 7 is connected to the wrapping sleeve 4 through an adhesive.

In this embodiment, the plastic optical fiber 61 is electrically connected to the light sensor 5.

In this embodiment, the support sleeve 7 is made of a plastic material.

Working principle: when a device is powered on through the first joint 1 of the data cable, an internal chip of the first joint 1 of the data cable transmits current to the inner wire rod 6 through the light sensor 5. At this time, the light sensor 5 is used to detect an external light. Therefore, when the external light is strong, luminous intensity of the plastic optical fiber 61 is high. When the external light is weak, the luminous intensity of the plastic optical fiber 61 is weak, thereby avoiding glare. During a use of the device, multiple wrapped wrapping sleeves 4 can work together with the support sleeve 7 to support the wire rod, avoiding an excessive bending and having a certain impact resistance effect. When the external impact is too large or the bending is too large, the frosted layer 62 is compressed and shattered. When the frosted layer 62 breaks, the transparent layer 63 can quickly fill a gap. At this time, light emitted by the plastic optical fiber 61 can be directly irradiated through the gap through the transparent layer 63, brightness of the damaged area is higher than that of undamaged area, which serves as a reminder to people that the device has been damaged, thus preventing further use and avoiding accidents.

The above shows and describes the basic principles, main features, and advantages of the present disclosure. Technicians in this filed should understand that the present disclosure is not limited by the embodiments. The descriptions in the embodiments and specification only illustrate the principles of the present disclosure. Without departing from the spirit and scope of the present disclosure, there may be various substitutions and improvements in the present disclosure, all of which fall within the protection scope of the claims.

What is claimed is:

1. A luminous data cable, comprising a data cable, a wrapping sleeve configured to protect the data cable, and an inner wire rod configured to emitting light; two ends of the data cable are respectively connected to a first joint of the data cable and a second joint of the data cable; the wrapping sleeve is a hollow structure, several wrapping sleeves are wrapped around an outside of the data cable, an inner part of the wrapping sleeve is provided with the inner wire rod along an axial direction, staggered positions of the several wrapping sleeves are fixed through a support sleeve;
the inner wire rod comprises a plastic optical fiber provided at one side in the wrapping sleeve that is close to the data cable, a transparent layer provided on an outer side of the plastic optical fiber, and a frosted layer provided between the plastic optical fiber and the transparent layer;
two sides of an inner of the first joint of the data cable is provided with a light sensor.

2. The luminous data cable according to claim 1, wherein the wrapping sleeve is made of a transparent material, the frosted layer is made of a brittle material.

3. The luminous data cable according to claim 2, wherein the support sleeve is connected to the wrapping sleeve by an adhesive.

4. The luminous data cable according to claim 3, wherein the plastic optical fiber is electrically connected to the light sensor.

5. The luminous data cable according to claim 4, wherein the support sleeve is made of a plastic material.
